(19) United States
(12) Patent Application Publication
(10) Pub. No.: US 2016/0147813 A1
(43) Pub. Date: May 26, 2016

(54) DISTRIBUTED TRANSACTION COMMIT PROTOCOL

(71) Applicants: Juchang LEE, Seoul (KR); Changgyoo PARK, Seoul (KR)

(72) Inventors: Juchang LEE, Seoul (KR); Changgyoo PARK, Seoul (KR)

(21) Appl. No.: 14/656,280

(22) Filed: Mar. 12, 2015

Related U.S. Application Data
(60) Provisional application No. 62/084,173, filed on Nov. 25, 2014.

(51) Int. Cl. G06F 17/30

(52) U.S. Cl. CPC G06F 17/30353; G06F 17/30371; G06F 17/30088

(57) ABSTRACT

Disclosed herein are system, method, and computer program product embodiments for implementing a distributed transaction commit protocol with low latency read and write transactions. An embodiment operates by first receiving a transaction, distributed across partial transactions to be processed at respective cohort nodes, from a client at a coordinator node. The coordinator node requests the cohort nodes to prepare to commit respective partial transactions. Upon receiving prepare commit results, the coordinator node generates a global commit timestamp for the transaction. Coordinator node then simultaneously sends the global commit timestamp to the cohort nodes and commit the transaction to a coordinator disk storage. Upon receiving both sending results from the cohort nodes and a committing result from the coordinator disk storage, the coordinator node provides a transaction commit result of the transaction to the client.

### BACKGROUND

Distributed database systems are often needed to process the vast amounts of data in the current big data world because database systems individually do not have enough memory or processing capabilities to process big data efficiently. Distributed transaction commit protocols are used by distributed database systems for transaction processing in order to maintain consistency of the data and concurrency control. Traditional transaction commit protocols typically require multiple phases and I/O (input/output) operations, which introduce significant multi-node distributed read and write transaction latencies during transaction processing.

### BRIEF DESCRIPTION OF THE DRAWINGS

The accompanying drawings are incorporated herein and form a part of the specification.

FIG. 1 is a block diagram of a distributed database system implementing a distributed transaction commit protocol, according to an example embodiment.

FIG. 2 is a block diagram of example components within a coordinator node, according to an example embodiment.

FIG. 3 is a block diagram of example components within a cohort node, according to an example embodiment.

FIG. 4 is a sequence diagram illustrating a process for implementing a distributed commit protocol with early commit acknowledgement, according to an example embodiment.

FIG. 5 is a sequence diagram illustrating a process for implementing a distributed commit protocol with early commit acknowledgement and early commit timestamp synchronization, according to an example embodiment.

FIG. 6 is a flow chart illustrating steps for performing the distributed commit protocol at a coordinator node, according to an example embodiment.

FIG. 7 is a flow chart illustrating steps for performing the distributed commit protocol at a cohort node, according to an example embodiment.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for implementing, within a distributed database system, an improved distributed transaction commit protocol with minimized response times for read and write transactions. For example, embodiments may allow the distributed database system to return a commit result, such as a commit acknowledgment, to a client earlier than in traditional transaction commit protocols. In an embodiment, the various I/O (input/output) operations may be performed in parallel to reduce response times for the read and write transactions.

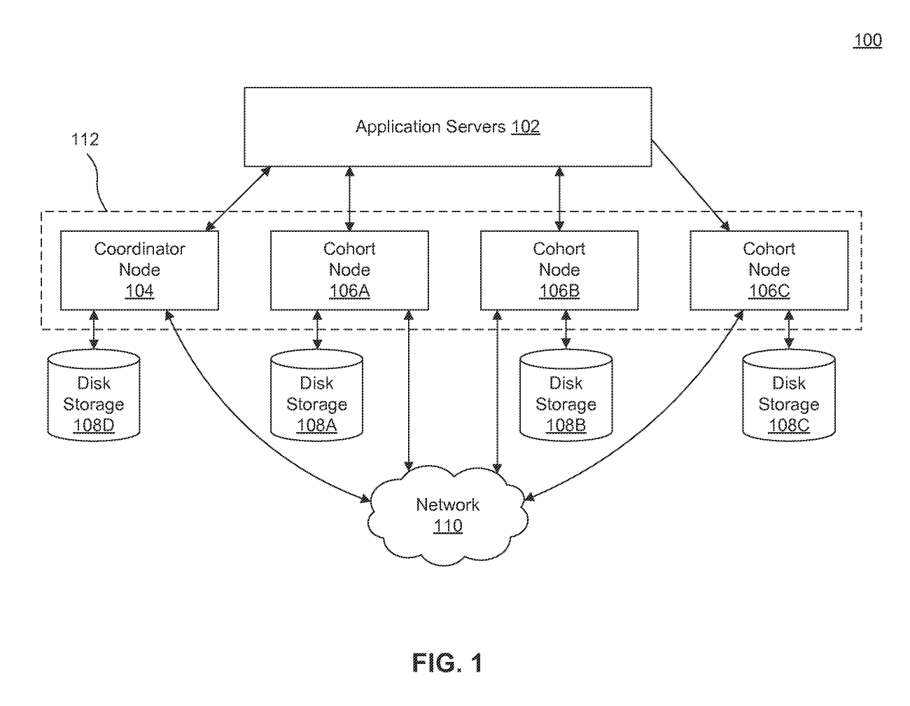

FIG. 1 illustrates a distributed database system 100 for implementing a distributed transaction commit protocol, according to an example embodiment. Distributed database system 100 may include one or more of each of the following: application servers 102, disk storage 108, nodes 112, and network 110. Nodes 112 may be differentiated into coordinator node 104 and cohort node 106. In an embodiment, one or more coordinator node 104 may be selected from one or more cohort nodes 106. In distributed systems, nodes 112 and application servers 102 may each be implemented using one or more servers and/or computers. Computers, such as personal computers, may also be configured to run client and/or server software.

Network 110 may enable coordinator node 104 and cohort nodes 106 to communicate with one another in distributed database system 100. In an embodiment (not shown), network 110 may enable application servers 102 to communicate with one or more of nodes 112. Network 110 may be an enterprise local area network (LAN) utilizing Ethernet communications, although other wired and/or wireless communication techniques, protocols and technologies may be used.

Application servers 102 (or application nodes) may communicate with one or more of nodes 112 and act as a client interface for users. Users may access and manipulate databases stored on nodes 112 and/or disk storage 108 controlled by nodes 112 through application servers 102. In an embodiment, one of the application servers 102 may be configured to communicate with only one of nodes 112 that provides the one application server the best performance. In an embodiment, one of application servers 102 that initiated a distributed transaction may be in direct communication with cohort node 106A. The distributed transaction may be distributed across one or more participating nodes 112 via cohort node 106A although the one application server is not in direct communication with coordinator node 104.

Coordinator node 104 may coordinate the distributed commit procedure for transactions distributed across cohort nodes 106. Transactions that may require the distributed commit procedure may typically be distributed write transactions. In an embodiment, coordinator node 104 may also distribute transactions across cohort nodes 106. Depending on the transaction, coordinator node 104 may distribute operations of the transaction across a subset of cohort nodes 106 that participate in the transaction. Each of the participating cohort nodes 106 may be configured to receive and process respective partial transactions. By processing the respective partial transactions, participating cohort nodes 106 may effectively process the transaction. In an embodiment, coordinator node 104 may contain the capability and software/hardware components to process a partial transaction. Therefore, coordinator node 104 may additionally perform the functionality of cohort nodes 106. In an embodiment, coordinator node 104 may distribute transactions across coordinator node 104 and cohort nodes 106.

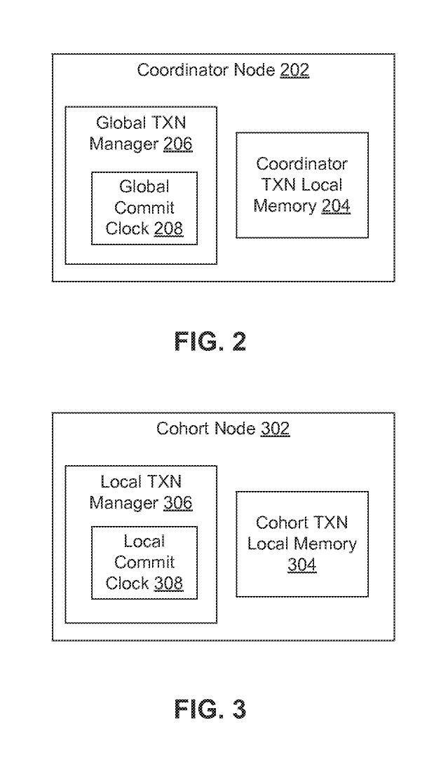

FIG. 2 is a block diagram illustrating components within a coordinator node 202, such as coordinator node 104, according to an example embodiment. Coordinator node 202 may include global TXN (transaction) manager 206, which maintains global commit clock 208, and coordinator TXN (transaction) local memory 204.

Coordinator node 202 may maintain distributed transactions and respective statuses within coordinator TXN local memory 204. In an embodiment, coordinator TXN local memory 204 may contain a table that associates transactions with respective states. Each state in the table may indicate a current status of a particular transaction. In an embodiments, the states of a transaction may include START, END, and EXCEPTION. The START state may indicate a distributed transaction has been initiated and is undergoing processing. In an embodiment, states may include READ and WRITE, which may be states in addition to or in place of the START state. Coordinator node 202 may be configured to designate a READ or WRITE state for a transaction based on whether it is a distributed read or write transaction, respectively. The END state may indicate the distributed transaction has successfully committed and/or persisted.

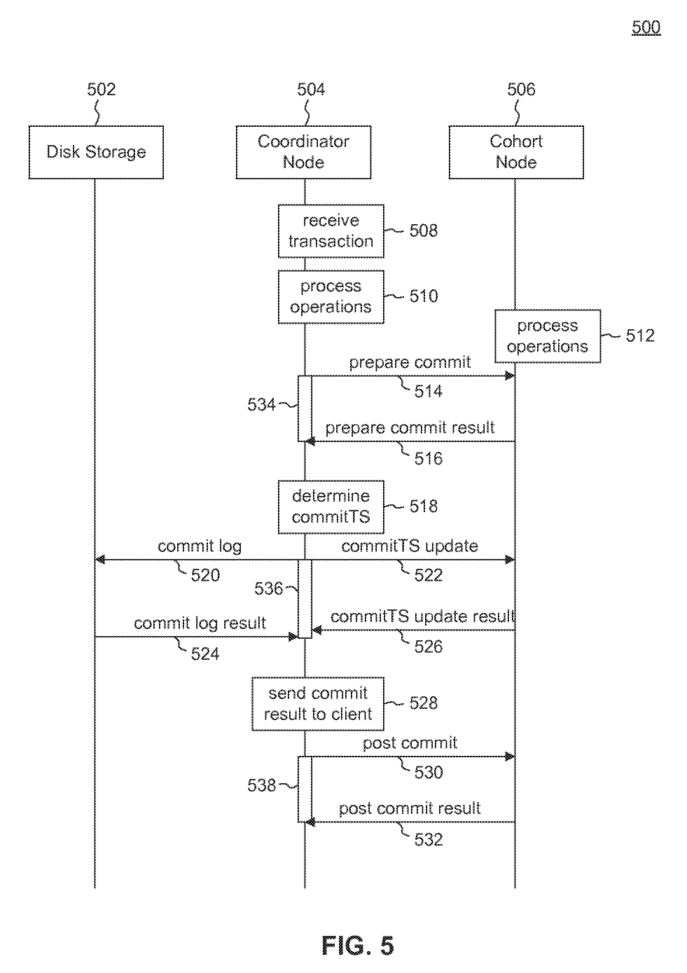

The EXCEPTION state may indicate an error was encountered while attempting to commit the distributed transaction. The error may be encountered at any stage of the commit procedure, as will be discussed in FIG. 5. In an embodiment, the EXCEPTION state may require the distributed transaction to be aborted. Coordinator node 202 may consequently require participant cohort nodes 106 to rollback any partial transactions associated with the distributed transaction. In an embodiment, other states or sub-states associated with EXCEPTION may be stored in coordinator TXN local memory 204 to log finer granularity error information.

In an embodiment, states may indicate a commit status of a distributed transaction at various stages in the commit procedure. For example states may include START, PRE-COMMIT, COMMIT, and POST-COMMIT. These example states correspond to possible commit phases under which a distributed transaction is currently being processed. Further details of the commit phases are discussed in FIG. 5.

In addition to tracking states, coordinator node 202 may be configured to store a global commit timestamp associated with a distributed transaction, such as a distributed write transaction, upon determining the distributed transaction can be successfully committed at the cohort nodes 106 participating in the distributed transaction. The global commit timestamp may be stored, for example, in a table in coordinator TXN local memory 204.

Coordinator node 202 may contain global TXN manager 206, which may track and update global commit clock 208. In distributed database system 100, global commit clock 208 may be necessary to maintain a synchronized and consistent commit time of distributed transactions across nodes 112. In an embodiment, a value of global commit clock 208 may be propagated to selected cohort nodes 106 to update respective local commit clocks at cohort nodes 106.

Global commit clock 208 may be configured as a counter that stores integer values. In an embodiment, global commit clock 208 may be configured to store digital timestamps. In an embodiment, global TXN manager 206 updates global commit clock 208 when coordinator node 202 commits a distributed transaction. In an embodiment, global TXN manager 206 updates global commit clock 208 by incrementing the stored value if a distributed write transaction is to be committed. As part of committing a distributed transaction, global TXN manager 206 may copy the updated value in the global commit clock 208 into coordinator TXN local memory 204 as the global commit timestamp associated with the distributed transaction. The updated global commit clock 208 may be sent to cohort nodes 106 participating in the distributed transaction.

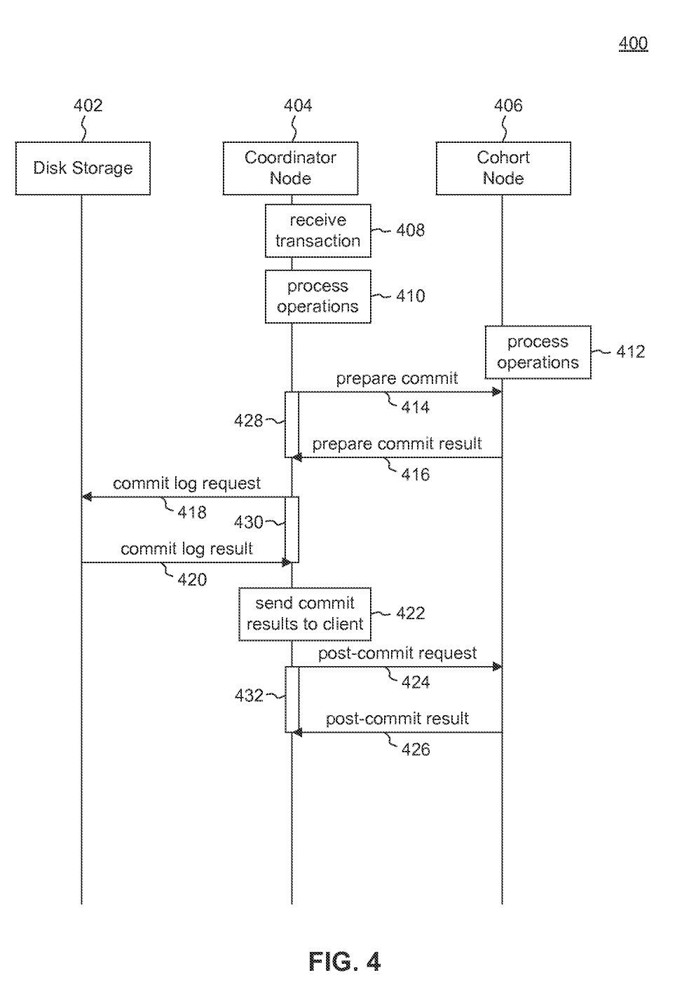

In distributed database system 100, coordinator node 104 may be necessary to ensure distributed transactions, especially distributed write transactions, are committed synchronously so that databases residing in nodes 112 in distributed database system 100 remain consistent and/or coherent. Coordinator node 104 may perform commits for the distributed transactions in basic phases: commit request phase, and commit phase. These basic phases may be performed using various network I/O operations and/or disk I/O operations. The specific procedures are discussed in FIGS. 4-7 below.

Cohort nodes 106 may comprise one or more databases and process the distributed transactions discussed above. A cohort node 106A may have access to disk storage 108A, which may be used to persist databases and/or transaction logs on cohort node 106A. As previously discussed, cohort node 106A (or coordinator node 104) may be in direct communication with one or more of application servers 102. Therefore, cohort node 106A may facilitate read and/or write transactions initiated by the one or more application servers 102. In an embodiment, when a transaction request, particularly a distributed write transaction request, is received by cohort node 106A, cohort node 106A may forward the transaction to coordinator node 104 through network 110. The transaction may then be distributed to cohort nodes 106 via coordinator node 104. In an embodiment, part of the transaction may also remain and be processed at coordinator node 104.

FIG. 3 is a block diagram illustrating components within a cohort node 302, such as coordinator node 106, according to an example embodiment. Cohort node 302 may include local TXN (transaction) manager 306, local commit clock 308, and cohort TXN (transaction) local memory 304, which respectively correspond to global TXN manager 206, global commit clock 208, and coordinator TXN local memory 204.

Whereas coordinator node 202 may maintain distributed transactions and respective statuses, cohort node 302 may maintain partial transactions and respective statuses within cohort TXN local memory 304. A partial transaction may be the portion of a distributed transaction, maintained at coordinator node 202, that is processed at cohort node 302. Similar to the states stored in coordinator TXN local memory 204, cohort node 302 may also track a status of a partial transaction by associating the partial transaction with one of the following states: START, EXCEPTION, READ, WRITE, PRE-COMMIT, COMMIT, and POST-COMMIT.

In addition to tracking the state of a partial transaction, cohort node 302 may also be configured to store a local commit timestamp of a partial transaction that is associated with a distributed transaction upon receiving a request to commit the distributed transaction. The local commit timestamp may be stored, for example, in a table in cohort TXN local memory 304.

Cohort node 302 may contain local TXN manager 306, which may track and update local commit clock 308. In an embodiment, local commit clock 308 may be used by transactions received at cohort node 302. For example, when a read transaction is received at cohort node 302, local TXN manager 306 may create a snapshot with an associated timestamp corresponding to a value of the local commit clock 308.

Local commit clock 308 may be configured as a counter that stores integer values. In an embodiment, local commit clock 308 may be configured to store digital timestamps. In an embodiment, local TXN manager 306 only updates local commit clock 308 when cohort node 302 receives an updated global commit clock 208 from coordinator node 202. In an embodiment, local TXN manager 306 updates local commit clock 308 with the value of global commit clock 208 when cohort node 302 receives a request by coordinator node 202 to commit a distributed transaction. The request may include an updated global commit clock 208. As part of committing a partial transaction, local TXN manager 306 may copy the updated value in the local commit clock 308 into local TXN local memory 304 as the local commit timestamp associated with the partial transaction.

FIG. 4 is a sequence diagram illustrating a process 400 for implementing a distributed commit protocol with early commit results among disk storage 402, coordinator node 404, and cohort node 406, according to an example embodiment. Though only one cohort node 406 is displayed, process 400 may be extended to include multiple cohort nodes. Components 402, 404, and 406 may correspond to disk storage 108, coordinator node 104 and coordinator node 204, and cohort node 106 and cohort node 206 from FIGS. 1-2, respectively. Process 400 may be performed by processing logic that may comprise hardware (e.g., circuitry, dedicated logic, programmable logic, microcode, etc.), software (e.g., instructions run on a processing device), or a combination thereof.

In step 408, coordinator node 404 may receive a transaction, such as a distributed write transaction. As discussed, the transaction may be received from application servers 102 in FIG. 1. In an embodiment discussed in FIG. 1, the distributed write transaction to be distributed across cohort node(s) 406 may have been received at and forwarded from cohort node 406 to coordinator node 404. In the exemplary embodiment of FIG. 4, the distributed write transaction may have started at coordinator node 406. Coordinator node 404 may store the distributed write transaction in coordinator TXN local memory 204 and update an associated status to START state and/or WRITE state, according to an embodiment.

In step 410, coordinator node 204 may process at least a portion of the operations associated with the distributed write transaction on coordinator node 404. The portion of the operations may be the operations designated by the distributed write transaction for coordinator node 404. In an embodiment, coordinator node 404 may also record the distribute write transaction and associated operations to transaction logs on coordinator node 404.

In step 412, cohort node 406 may process a partial transaction associated with the distributed write transaction on cohort node 406. The partial transaction may comprise at least a portion of the operations of the distributed write transaction. The portion of the operations may be the operations designated by the distributed write transaction for processing at cohort node 406. In an embodiment the distributed write transaction may have been distributed into partial transactions to be processed across coordinator node 404 and cohort node(s) 406. In an embodiment, cohort node 406 may have received the partial transaction from coordinator node 404. Cohort node 406 may store the partial transaction in cohort TXN local memory 304 and update an associated status to START state and/or WRITE state, according to an embodiment.

In step 414, coordinator node 404 may request cohort node(s) 206 involved in the write transaction to prepare to commit the distributed write transaction through a prepare commit request. The prepare commit request may be a network 10 operation since the coordinator node 404 may communicate with cohort node 406 through network 110. As part of step 414, coordinator node 404 may update a status of the distributed write transaction to PRE-COMMIT to indicate the distributed write transaction is currently in a prepare commit phase.

Coordinator node 404 may initiate a request to prepare to commit the distributed write transaction in response to a commit request from application servers 102. In an embodiment, a user may initiate, via application servers 102, a request to commit INSERT, WRITE, or UPDATE commands.

Upon receiving the prepare commit request, cohort node 406 may update databases and/or transaction logs on cohort node 406 associated with the partial transaction. The transaction logs may include undo and redo logs, which allow cohort node 406 to undo or redo transactions when necessary, such as for aborted transactions or recovery. In an embodiment, databases and/or transaction logs may be persisted to a disk storage, such as disk storage 108C, associated with cohort node 406, such as cohort node 106C. Cohort node 406 may update the status of the partial transaction to a COMMIT state in cohort TXN local memory 304. If an error occurs, the status may alternatively be updated to an EXCEPTION state.

In step 416, upon processing the prepare commit request, cohort node 406 may send a prepare commit result to coordinator node 404 indicating whether the partial transaction was successfully prepared on cohort node 406. In an embodiment, the prepare commit result is an acknowledgement (ACK) message. The prepare commit result may be transmitted via a network IO operation, which introduces a significant delay in transaction processing.

Coordinator node 404 may need to receive a prepare commit result 416 from each of the cohort node(s) 406 involved in the distributed write transaction before further processing. Pre-commit latency 428 indicates the time that coordinator node 404 was idle while waiting for the prepare commit result(s) 416. If any of the results indicates an exception, the distributed transaction may need to be aborted. In an embodiment, coordinator node 404 requests cohort node(s) 406 to rollback respective partial transactions using respective undo logs at cohort node(s) 406.

In step 418, coordinator node 404 may request disk storage 402 to commit the transaction log containing the distributed write transaction (and associated operations) through a commit log request. The commit log request may be a type of disk IO operation. Disk storage 402 may then persist the log.

In step 420, coordinator node 404 may receive a commit log result such as a commit log acknowledgement (ACK) from disk storage 402. The commit log result may indicate whether disk storage 402 successfully committed the log. Upon receiving the commit log result, global TXN manager 206 may update global commit clock 208 and assign a global commit timestamp to the distributed write transaction stored in coordinator TXN local memory 204. Commit log latency 430 indicates the time that coordinator node 404 was idle while waiting for the commit log result 420. If an error was encountered at disk storage 402, coordinator node 404 may receive an exception in the commit log result. The exception result may be used to update a status of the distributed transaction. In an embodiment, coordinator node 404 may retry step 418 and/or request cohort node(s) 406 to rollback respective partial transactions.

In step 422, in response to receiving a commit log result, coordinator node 404 may issue a commit transaction result to a client/user operating application servers 102. The commit transaction result may be an ACK indicating the distributed write transaction has been successfully committed. Upon sending the commit transaction result, coordinator node 404 may update the status of the distributed transaction to a COMMIT state.

In step 424, coordinator node 404 may request participating cohort node(s) 406 to commit the transaction through a commit request. The commit request may be a type of network IO operation. In an embodiment, for the distributed write transaction, the commit request may include a value of global commit clock 208 and/or a commit timestamp for the partial transaction to be committed at cohort node 406. Upon receiving the commit request, cohort node 406 may update local commit clock 308 and a local commit timestamp of the partial transaction with the received information. The status of the partial transaction may be updated to COMMIT. If an error occurs, the status may be updated to an EXCEPTION state.

In step 426, coordinator node 204 may receive a commit result 426 from each cohort node(s) 406 involved in the distributed write transaction indicating whether the distributed write transaction was successfully committed at the respective cohort node(s) 406. The commit result may be a type of network IO operation. Commit latency 432 indicates the time that coordinator node 404 was idle while waiting for the commit result(s) in step 426.

In an embodiment, the commit request and commit result(s) may be synchronous operations. After receiving a commit result from each of the cohort node(s) 406 participating in the distributed write transaction, coordinator node 404 may mark the end of processing the distributed write transaction by updating an associated status to the END state. The transactions may then be removed from coordinator TXN local memory 204. In an embodiment, the commit request may be asynchronous operations.

By having coordinator node 404 return a commit transaction result in step 422 to a client/user operating application servers 102 before requesting cohort server(s) 406 to perform commit procedures in step 424, response time for multi-node distributed write transactions may be significantly reduced. Therefore, the post-commit latency 432 may not contribute to latency for providing commit results to application servers 102.

However, if the client operating application servers 102 executes, for example, a read transaction at cohort node 406 after receiving a commit transaction result of a distributed write transaction in step 422, cohort node 406 may not have committed the previous distributed write transaction. This race condition may occur because cohort node 406 receives a commit timestamp for the previous distributed write transaction along with the request to commit the distributed write transaction at step 424, which occurs after application servers 102 receives a commit transaction result. In an embodiment, a read transaction may be assigned a snapshot timestamp (TS) that corresponds to local commit clock 308. In this embodiment, the snapshot TS may be less than the commit timestamp of the distributed write transaction and an incorrect non-updated value may be read. Alternatively, the snapshot timestamp may correspond to global commit clock 208 if the read transaction is performed at coordinator node 404.

To ensure the correct value is to be read such that the system remains consistent, additional dependency logic between read transactions and any multi-node distributed write transactions ongoing in parallel to those read transactions may be required. This additional dependency logic may introduce high performance overhead and associated latencies for subsequent transactions, especially read transactions.

FIG. 5 is a sequence diagram illustrating a process 500 for implementing a distributed commit protocol with early commit results and early commit timestamp synchronization among disk storage 502, coordinator node 504, and cohort node 506, according to an example embodiment. The combination of early commit results and early commit timestamp synchronization may minimize latencies for distributed read and write transactions. Though only one cohort node 506 is displayed, process 500 may be extended to include multiple cohort node(s) 506. Components 502, 504, and 506 may correspond to disk storage 108, coordinator node 104 and coordinator node 204, and cohort node 106 and cohort node 206 from FIGS. 1-2, respectively. Process 500 may be performed by processing logic that may comprise hardware (e.g., circuitry, dedicated logic, programmable logic, microcode, etc.), software (e.g., instructions run on a processing device), or a combination thereof.

Process 500 includes early commit timestamp synchronization, which improves upon the distributed commit protocol illustrated in process 400 of FIG. 4. Accordingly, many steps in process 500 may mirror steps described in process 400. Particularly, in an embodiment, steps 508-516 may exactly correspond to steps 408-416, respectively.

In step 508, coordinator node 504 may receive a distributed transaction, such as a distributed write transaction. In an embodiment discussed in FIG. 1, a status of the distributed transaction may be updated in coordinator TXN local memory 204. Further embodiments are discussed in step 408 of FIG. 4.

In step 510, coordinator node 504 may process at least a portion of the operations associated with the distributed write transaction on coordinator node 504. The portion of the operations may be the operations designated by the distributed write transaction for coordinator node 504. In an embodiment, coordinator node 504 may also record the distribute write transaction and associated operations to transaction logs on coordinator node 504.

In step 512, cohort node 506 may process a partial transaction associated with the distributed write transaction on cohort node 506. Cohort node 506 may store the partial transaction in cohort TXN local memory 304 and update an associated status to START state and/or WRITE state, accordingly to an embodiment. Further embodiments are discussed in step 412 of FIG. 4.

In step 514, coordinator node 504 may request cohort node(s) 506 involved in the write transaction to prepare to commit the distributed write transaction through a prepare commit request. In an embodiment, coordinator node 504 may update a status of the distributed write transaction to COMMIT to indicate the distributed write transaction is currently in a prepare commit phase. Upon receiving the prepare commit request, cohort node 506 may update databases and/or transaction logs on cohort node 506 associated with the partial transaction according to embodiments discussed in step 414 of FIG. 4.

In step 516, upon processing the prepare commit request, cohort node 506 may send a prepare commit result to coordinator node 504 indicating whether the partial transaction was successfully prepared on cohort node 506. Further embodiments are discussed in step 416 of FIG. 4.

Coordinator node 504 may need to receive a prepare commit result 516 from each of the cohort node(s) 506 participating in the distributed write transaction before further processing. Pre-commit latency 534 indicates the time that coordinator node 504 was idle while waiting for the prepare commit result(s) 516.

In step 518, global TXN manager 206 within coordinator node 504 may determine a global commit timestamp (TS) for the distributed write transaction upon receiving pre-commit results from the participating cohort node(s) 506. In an embodiment, when no exception results are received at coordinator node 504, global TXN manager 206 may update global commit clock 208. The value within global commit clock 208 may be incremented, according to an embodiment discussed in FIG. 2. In an embodiment, global commit clock 208 may be updated to reflect a current time at coordinator node 504 when the prepare commit results from cohort node(s) 306 were received in step 516. The determined global commit timestamp may be the update value of global commit clock 208. Accordingly, the global commit timestamp associated with the distributed write transaction may be logged in coordinator TXN local memory 204.

In step 520, coordinator node 504 may request disk storage 502 to commit the transaction log containing the distributed write transaction (and associated operations) through a commit log request. The commit log request may be a type of disk IO operation. Disk storage 502 may then persist the log.

In step 522, coordinator node 504 may request participating cohort node(s) 506 to commit the respective partial transactions using the determined global commit timestamp (TS) for the distributed transaction. In an embodiment, coordinator node 504 may send a value of global commit clock 208 to cohort node(s) 506. Using the updated value, local TXN manager 306 may update local commit clock 308 and cohort node 506 may store a local commit timestamp associated with the partial transaction in cohort TXN local memory 304. In an embodiment, coordinator node 504 may also send a global commit timestamp of the distributed transaction. The global commit timestamp may be used by cohort node 506 to assign the local commit timestamp. In order to reduce the impact of disk IO operation, such as step 520, and network 10 operation, such as step 522, step 522 may be performed concurrently and/or at substantially the same time as step 520. The commit timestamp (TS) update request may be a type of synchronous network IO operation.

In step 524, coordinator node 504 may receive a commit log result, such as a commit log acknowledgement (ACK), from disk storage 502 indicating whether disk storage 502 successfully committed the log.

In step 526, coordinator node 504 may receive commit timestamp (TS) update result, such as acknowledgement(s) (ACKs), from cohort node(s) 506 participating in the distributed transaction. Commit latency 536 indicates the time that coordinator node 504 was idle while waiting for both the commit log result from step 524 and commit timestamp update result(s) from step 526.

In step 528, in response to receiving commit log result from step 524 and commit timestamp update result(s) from step 526, coordinator node 504 may send a commit transaction result, such as an acknowledgement, to a client/user operating application servers 102 indicating the distributed transaction has been successfully committed. In an embodiment, if any of the result indicated an exception or error, coordinator node 504 may retry steps 520 and/or 522. In an embodiment, coordinator node 504 may abort the distributed transaction and request cohort node(s) 506 to rollback or undo commits of respective partial transactions. Upon sending the commit transaction result to the client, processing of the distributed transaction may proceed to a POST-COMMIT phase and the associated status may be updated accordingly.

In step 530, coordinator node 504 may request participating cohort node(s) 506 to perform any post-commit processing of the distributed transaction through a post-commit request. The post-commit request may be a type of network IO operation. In an embodiment, the post-commit request may include an after-commit timestamp for the distributed transaction to verify the partial transactions was successfully committed at respective cohort node(s) 506. In an embodiment, upon receiving the post-commit request and no exceptions occur, cohort node 506 may remove partial transactions stored in cohort TXN local memory 304. In an embodiment, a status associated with a partial transaction may be updated to END, and cohort node 506 may remove the partial transaction as a batched process at a later time. Partial transactions assigned an EXCEPTION status may also be removed.

In step 532, coordinator node 504 may receive a post-commit result 532 from cohort node(s) 506 participating in the distributed transaction. A post-commit result may indicate whether the partial transaction was successfully verified as committed at the respective cohort node 506. The post-commit result may be a type of network IO operation. Post-commit latency 538 may indicate the time that coordinator node 504 was idle while waiting for the post-commit result(s) in step 532.

Similar to FIG. 4, the commit transaction result, such as an acknowledgement (in step 528), was issued after pre-commit latency 534 and commit latency 536, but before post-commit latency 532. Therefore, distributed write transaction response times are also reduced and similarly optimized. However, whereas the commit timestamp of the distributed write transaction was determined in step 444 in FIG. 4, coordinator node 504 determines the commit timestamp (in step 518) prior to writing its commit log to disk storage 502 (in step 520).

Since the commit transaction result was only issued after coordinator node 504 receives commit timestamp update result(s) in step 526 and commit log result in step 524, a timestamp, such as a snapshot timestamp, associated with a read transaction occurring after the commit transaction result in step 528 is guaranteed to be earlier than the committed timestamp of a previously committed distributed write transaction. Therefore, the distributed transaction commit protocol in FIG. 5 may optimize both multi-node distributed write transactions and read transactions concurrently being processed while maintaining a consistent view of distributed database system 100.

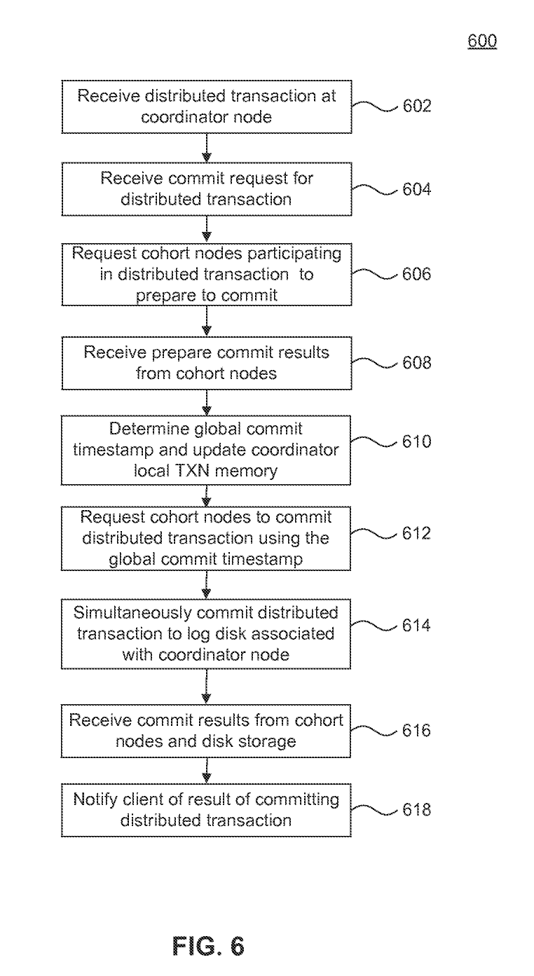

FIG. 6 is a flow chart illustrating method 600 for performing the distributed commit protocol at a coordinator node 504, according to an example embodiment. Steps of method 600 corresponds to steps and embodiments discussed in process 500 of FIG. 5. Method 600 may be performed by processing logic that may comprise hardware (e.g., circuitry, dedicated logic, programmable logic, microcode, etc.), software (e.g., instructions run on a processing device), or a combination thereof.

In a START phase of the distributed commit protocol, coordinator node 504 may receive a distributed transaction in step 602. The distributed transaction may be received directly from application servers 102 or from cohort node 506, which forwards the distributed transaction from application servers 102. In step 604, coordinator node 504 may receive a commit request for the distributed transaction from application servers 102.

In a PRE-COMMIT phase of the distributed commit protocol, coordinator node 504 may request cohort node(s) 506 participating in distributed transaction to prepare to commit the distributed transaction in step 606. In step 608, coordinator node 504 may receive prepare commit results from participating cohort node(s) 506.

In a COMMIT phase of the distributed commit protocol, upon receiving the prepare commit results of step 608, coordinator node 504 may determine a global commit timestamp for the distributed transaction and store the value in coordinator local TXN memory 204. In an embodiment, the determined global commit timestamp may be copied from global commit clock 208, which may be incremented whenever a distributed write transaction is to be committed. In step 612, coordinator node 504 may request cohort node(s) 506 to commit the distributed transaction using the global commit timestamp and/or global commit clock 208. In step 614, coordinator node 504 may concurrently commit a log of the distributed transaction to disk storage 502 associated with coordinator node 502. In step 616, coordinator node 504 may receive commit results from cohort node(s) 506 and commit log result from disk storage 502. In step 618, coordinator node 504 may notify a client via application servers 102 about whether the distributed transaction committed successfully.

In a POST-COMMIT phase (not shown) which may correspond to steps 530 and 532 of FIG. 5, distributed transactions may be removed from coordinator TXN local memory 204 because they have been successfully committed and may no longer be needed. In an embodiment, upon notifying a client of exceptions, the distributed transactions in an EXCEPTION state may also be removed.

Within the exemplary phases discussed above, coordinator node 504 may update the statuses of respective distributed transactions to correspond to the respective current processing states.

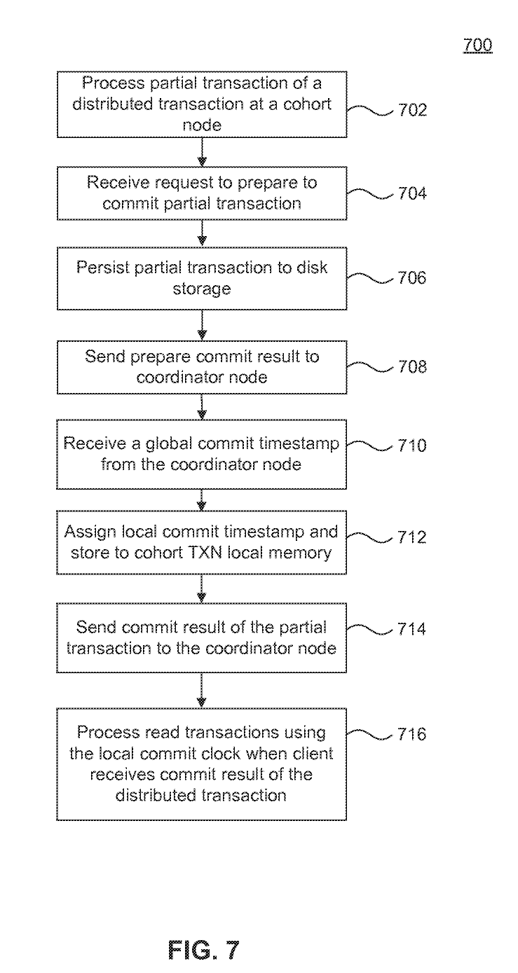

FIG. 7 is a flow chart illustrating method 700 for performing the distributed commit protocol at a cohort node 506, according to an example embodiment. Steps of method 700 corresponds to steps and embodiments discussed in process 500 of FIG. 5. Method 700 may be performed by processing logic that may comprise hardware (e.g., circuitry, dedicated logic, programmable logic, microcode, etc.), software (e.g., instructions run on a processing device), or a combination thereof.

In a START phase of the distributed commit protocol, cohort node 506 may receive a partial transaction and then proceed to process the partial transaction in step 702.

In a PRE-COMMIT phase of the distributed commit protocol, cohort node(s) 506 may receive, from coordinator node 504, a request to prepare to commit a partial transaction in step 704. In step 706, cohort node(s) 506 may persist the partial transaction to disk storage associated with cohort node 506. In step 708, cohort node(s) 506 may send prepare commit results to coordinator node 504.

In a COMMIT phase of the distributed commit protocol, cohort node(s) 506 may receive a global commit timestamp from coordinator node 504 in step 710. In an embodiment, cohort node(s) 506 may receive a value of global commit clock 208 or both the value and global commit timestamp from coordinator node 504. In step 712, based on the received information, cohort node(s) 506 may assign a local commit timestamp to the respective partial transaction and store the local commit timestamp to cohort TXN local memory 304. In an embodiment, local TXN manager 306 may update local commit clock 308 by replacing an old value with the received global commit clock 208. In step 714, cohort node(s) 506 may send commit result(s) of the respective partial transaction(s) to coordinator node 504.

In a POST-COMMIT phase, which may correspond to steps 530 and 532 of FIG. 5 (not shown), distributed transactions may be removed from cohort TXN local memory 304 because they have been successfully committed and may no longer be needed. In an embodiment, the distributed transactions in an EXCEPTION state may also be removed.

In step 716, when a read transaction is initiated by a client at cohort node 506 subsequent to updating the local commit clock 308, the read transaction may be assigned a snapshot timestamp corresponding to the updated local commit clock 308. Since the client receives a commit result of the distributed transaction after the local commit clock 308 and local commit timestamp of the partial transactions are updated, the result of the read transaction is guaranteed to be accurate.

Within the exemplary phases discussed above, cohort node 506 may update the statuses of respective distributed transactions to correspond to the respective current processing states.

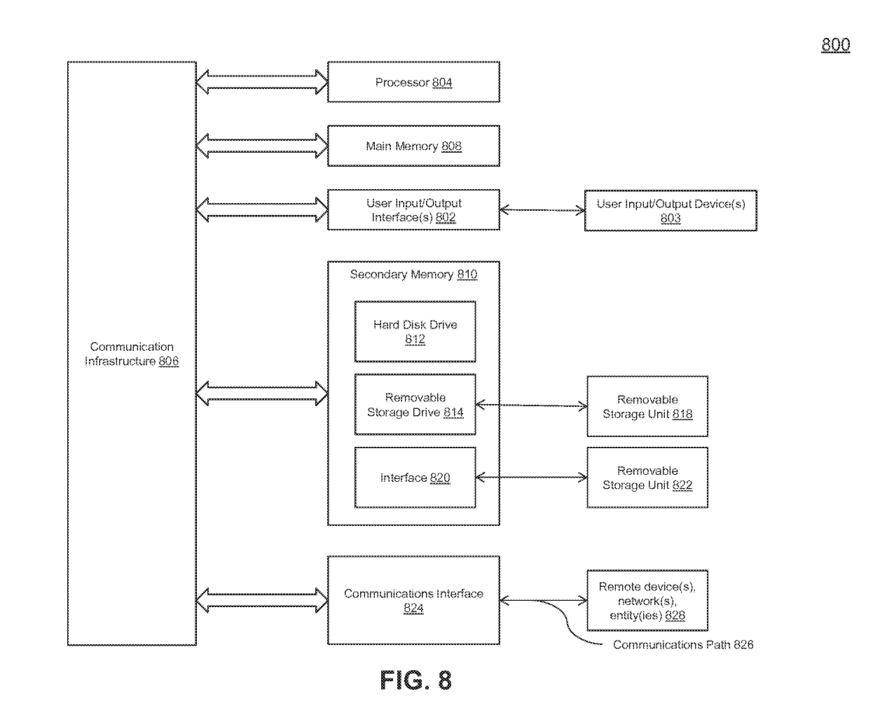

Various embodiments can be implemented, for example, using one or more well-known computer systems, such as computer system 800 shown in FIG. 8. Computer system 800 can be any well-known computer capable of performing the functions described herein.

Computer system 800 includes one or more processors (also called central processing units, or CPUs), such as a processor 804. Processor 804 is connected to a communication infrastructure or bus 806.

One or more processors 804 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 also includes user input/output device(s) 803, such as monitors, keyboards, pointing devices, etc., that communicate with communication infrastructure 806 through user input/output interface(s) 802.

Computer system 800 also includes a main or primary memory 808, such as random access memory (RAM). Main memory 808 may include one or more levels of cache. Main memory 808 has stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to an exemplary embodiment, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

In an embodiment, a tangible apparatus or article of manufacture comprising a tangible computer useable or readable medium having control logic (software) stored thereon is also referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use embodiments using data processing devices, computer systems and/or computer architectures other than that shown in FIG. 8. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments as contemplated by the inventor(s), and thus, are not intended to limit the disclosure or the appended claims in any way.

While the disclosure has been described herein with reference to exemplary embodiments for exemplary fields and applications, it should be understood that the scope of the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

What is claimed is:

1. A method, comprising:
receiving, by a coordinator node, a transaction distributed across partial transactions to be executed on respective cohort nodes participating in the transaction;
receiving, by the coordinator node, prepare commit results for the respective partial transactions from the cohort nodes;
generating, by the coordinator node, a global commit timestamp associated with the transaction;
sending, by the coordinator node, the global commit timestamp to the cohort nodes; and
committing, in concurrence with the sending, the global commit timestamp and associated transaction to a coordinator disk storage,
wherein the coordinator node is implemented by at least one processor.

2. The method of claim 1, further comprising:
providing, upon receiving sending results from the cohort nodes and a committing result from the coordinator disk storage, a transaction commit result of the transaction to a client.

3. The method of claim 1, further comprising:
updating, upon receipt of prepare commit results of a write transaction, a counter storing a global commit clock by incrementing the counter.

4. The method of claim 3, wherein the generating comprises:
assigning the global commit timestamp using a value of the updated counter.

5. The method of claim 1, further comprising:
requesting the cohort nodes to update respective local commit timestamps associated with the respective partial write transactions to correspond to the global commit timestamp.

6. The method of claim 5, further comprising:
assigning a snapshot timestamp to a read transaction using a value of a counter for storing the global commit clock.

7. The method of claim 1, further comprising:
tracking a commit status of the transaction in a coordinator transaction local memory, wherein the tracked commit status enables the coordinator node to concurrently process multiple transactions.

8. A system, comprising:
a memory; and
a cohort node that is implemented by at least one processor coupled to the memory and configured to:
receive a transaction distributed across partial transactions to be executed on respective cohort nodes participating in the transaction, wherein the cohort nodes are implemented by at least one processor;
receive prepare commit results for the respective partial transactions from the cohort nodes;
generate a global commit timestamp associated with the transaction upon receipt of the prepare commit results;
send the global commit timestamp to the cohort nodes; and
commit, in concurrence with the sending, the global commit timestamp and associated transaction to a coordinator disk storage.

9. The system of claim 8, the cohort node further configured to:
provide, upon receiving sending results from the cohort nodes and a committing result from the coordinator disk storage, a transaction commit result of the transaction to a client.

10. The system of claim 8, the cohort node further configured to:
update, upon receipt of prepare commit results of a write transaction, a counter storing a global commit clock by incrementing the counter.

11. The system of claim 10, wherein to generate the global commit timestamp, the cohort node is configured to:
assign the global commit timestamp using a value of the updated counter.

12. The system of claim 8, the cohort node further configured to:
request the cohort nodes to update respective local commit timestamps associated with the respective partial write transactions to correspond to the global commit timestamp.

13. The system of claim 12, the cohort node further configured to:
assign a snapshot timestamp to a read transaction using a value of a counter for storing the global commit clock.

14. The system of claim 8, the cohort node further configured to:
track a commit status of the transaction in a coordinator transaction local memory, wherein the tracked commit status enables the coordinator node to concurrently process multiple transactions.

15. A tangible computer-readable device having instructions stored thereon that, when executed by at least one computing device, causes the at least one computing device to perform operations comprising:
receiving, by a coordinator node, a transaction distributed across partial transactions to be executed on respective cohort nodes participating in the transaction;
receiving, by the coordinator node, prepare commit results for the respective partial transactions from the cohort nodes;
generating, by the coordinator node, a global commit timestamp associated with the transaction;
sending, by the coordinator node, the global commit timestamp to the cohort nodes; and
committing, in concurrence with the sending, the global commit timestamp and associated transaction to a coordinator disk storage.

16. The computer-readable device of claim 15, the operations further comprising:
providing, upon receiving sending results from the cohort nodes and a committing result from the coordinator disk storage, a transaction commit result of the transaction to a client.

17. The computer-readable device of claim 15, the operations further comprising:
updating, upon receipt of prepare commit results of a write transaction, a counter storing a global commit clock by incrementing the counter; and
assigning the global commit timestamp using a value of the updated counter.

18. The computer-readable device of claim 15, the operations further comprising:
requesting the cohort nodes to update respective local commit timestamps associated with the respective partial write transactions to correspond to the global commit timestamp.

19. The computer-readable device of claim 17, the operations further comprising:
assigning a snapshot timestamp to a read transaction using a value of a counter for storing the global commit clock.

20. The computer-readable device of claim 15, the operations further comprising:
tracking a commit status of the transaction in a coordinator transaction local memory, wherein the tracked commit status enables the coordinator node to concurrently process multiple transactions.
